(19) United States
(12) Patent Application Publication
(10) Pub. No.: US 2025/0190667 A1
(43) Pub. Date: Jun. 12, 2025

(54) NON-TRANSITORY COMPUTER-READABLE RECORDING MEDIUM, ESTIMATION METHOD, LEARNED MODEL, AND METHOD OF GENERATING LEARNED MODEL

(71) Applicant: SUMITOMO ELECTRIC INDUSTRIES, LTD., Osaka (JP)

(72) Inventor: Takeshi KAWASAKI, Osaka-shi (JP)

(73) Assignee: SUMITOMO ELECTRIC INDUSTRIES, LTD., Osaka (JP)

(21) Appl. No.: 18/953,631

(22) Filed: Nov. 20, 2024

(30) Foreign Application Priority Data
Dec. 7, 2023 (JP) 2023-207204

(51) Int. Cl. G06F 30/337; G06F 30/27

(52) U.S. Cl. CPC G06F 30/337; G06F 30/27

(57) ABSTRACT

A non-transitory computer-readable recording medium having stored therein a program causes a computer to execute a process. The process includes acquiring first information related to a linear circuit having a plurality of ports for receiving or outputting a high frequency signal, and second information related to a frequency of the high frequency signal, estimating, when the second information indicates that the frequency is 0 Hz, an S-parameter for two ports of the plurality of ports when the frequency is 0 Hz, from the first information based on a first learned model, and estimating, when the second information indicates that the frequency is other than 0 Hz, an S-parameter at the frequency from the first information and the second information, based on a second learned model. The first and the second learned models are generated by performing machine learning on plural pieces of first training data and second training data, respectively.

### CROSS REFERENCE TO RELATED APPLICATIONS

This application claims priority based on Japanese Patent Application No. 2023-207204 filed on Dec. 7, 2023, and the entire contents of the Japanese Patent Application are incorporated herein by reference.

### TECHNICAL FIELD

The present invention relates to a non-transitory computer-readable recording medium, an estimation method, a learned model, and a method of generating a learned model.

### BACKGROUND ART

In circuit design of a high-frequency circuit, an equivalent circuit model using a lumped constant circuit including a lumped element is used (for example, Patent Literature 1: Japanese Laid-open Patent Application Publication No. S63-61970).

### SUMMARY OF THE INVENTION

An embodiment according to the present disclosure is a non-transitory computer-readable recording medium having stored therein a program for causing a computer to execute a process. The process includes acquiring first information related to a linear circuit having a plurality of ports for receiving or outputting a high frequency signal, and second information related to a frequency of the high frequency signal, estimating, when the second information indicates that the frequency is 0 Hz, an S-parameter for two ports of the plurality of ports when the frequency is 0 Hz, from the first information based on a first learned model, and estimating, when the second information indicates that the frequency is other than 0 Hz, an S-parameter at the frequency from the first information and the second information, based on a second learned model. The first learned model is generated by performing machine learning on a plurality of pieces of first training data, the plurality of pieces of first training data defining a relationship between a plurality of pieces of first information of the linear circuit and a plurality of S-parameters. Each of the plurality of S-parameters is calculated for a corresponding one of the plurality of pieces of first information when the frequency is 0 Hz. The second learned model is generated by performing machine learning on a plurality of pieces of second training data, the plurality of pieces of second training data defining a relationship among the plurality of pieces of first information of the linear circuit, a plurality of frequencies, and a plurality of S-parameters. Each of the plurality of frequencies includes a frequency other than 0 Hz. Each of the plurality of S-parameters is calculated for a corresponding one of the plurality of pieces of first information and a corresponding one of the plurality of frequencies.

An embodiment according to the present disclosure is a learned model for estimating an S-parameter for two ports of a plurality of ports for receiving or outputting a high frequency signal, based on first information related to a linear circuit having the plurality of ports and second information related to a frequency of the high frequency signal. The learned model includes a first learned model and a second learned model. The first learned model is generated by performing machine learning on a plurality of pieces of first training data defining a relationship between a plurality of pieces of first information and a plurality of S-parameters. Each of the plurality of S-parameters is calculated for a corresponding one of the plurality of pieces of first information when the frequency is 0 Hz. The second learned model is generated by performing machine learning on a plurality of pieces of second training data defining a relationship among the plurality of pieces of first information, a plurality of frequencies, and a plurality of S-parameters, each of the plurality of frequencies including a frequency other than 0 Hz. Each of the plurality of S-parameters is calculated for a corresponding one of the plurality of pieces of first information and a corresponding one of the plurality of frequencies.

An embodiment according to the present disclosure is a method of generating a learned model for estimating an S-parameter for two ports of a plurality of ports receiving or outputting a high frequency signal, based on first information related to a linear circuit having the plurality of ports and second information related to a frequency of the high frequency signal. The method includes generating a first learned model and generating a second learned model. The first learned model is generated by performing machine learning on a plurality of pieces of first training data defining a relationship between a plurality of pieces of first information and a plurality of S-parameters. Each of the plurality of S-parameters is calculated for a corresponding one of the plurality of pieces of first information when the frequency is 0 Hz. The second learned model is generated by performing machine learning on a plurality of pieces of second training data defining a relationship among the plurality of pieces of first information, a plurality of frequencies, and a plurality of S-parameters, each of the plurality of frequencies including a frequency other than 0 Hz. Each of the plurality of S-parameters is calculated for a corresponding one of the plurality of pieces of first information and a corresponding one of the plurality of frequencies.

The present disclosure can be implemented not only as such a characteristic non-transitory computer-readable recording medium and estimation method, but also as an estimation device that processes such characteristic steps. Furthermore, it can be implemented as a semiconductor integrated circuit that implements part or all of the estimation device, or as an estimation system that includes the estimation device.

### BRIEF DESCRIPTION OF THE DRAWINGS

FIG. 1 is a block diagram of a linear circuit for estimating an S-parameter in a first embodiment.

FIG. 2 is a plan view of an Example 1 of the linear circuit in the first embodiment.

FIG. 3 is a plan view and a cross-sectional view of an Example 2 of the linear circuit in the first embodiment.

FIG. 4 is a block diagram of a computer in the first embodiment.

FIG. 5 is a flowchart illustrating a method of generating training data in the first embodiment.

FIG. 6 is a diagram illustrating an example of the training data in the first embodiment.

FIG. 7 is a flowchart illustrating a method of generating a learned model in the first embodiment.

FIG. 8 is a functional block diagram of an estimation device in the first embodiment.

FIG. 9 is a flowchart illustrating a method of estimating the S-parameter in the first embodiment.

FIG. 10 is a flowchart illustrating a method of estimating an S-parameter in a first comparative example.

FIG. 11 is an equivalent circuit of the linear circuit.

FIG. 12 is a diagram illustrating S21 versus a resistance value R of a resistor R.

FIG. 13 is a diagram illustrating S21 when ports P1 and P2 are short-circuited at direct current.

FIG. 14 is a diagram illustrating S21 when ports P1 and P2 are opened at direct current.

### DETAILED DESCRIPTION

In a high frequency band where the frequency is high, the wavelength of a high frequency signal is not sufficiently large with respect to a lumped element. Thus, when the frequency changes, the high-frequency characteristics of the high-frequency circuit may not match the equivalent circuit model using a lumped constant circuit. In addition, in the model in which the high-frequency circuit is represented by an S-parameter, it is difficult to create a model each time the configuration of the high-frequency circuit is changed. There is a method of estimating the S-parameter of the high-frequency circuit using a machine learned model, however, the accuracy of the S-parameter may be lowered.

The present disclosure has been made in view of the above problems, and an object of the present disclosure is to improve the accuracy of the S-parameter. [Description of Embodiments of Present Disclosure]

First, the contents of embodiments according to the present disclosure will be listed and described.

(1) An embodiment according to the present disclosure is a non-transitory computer-readable recording medium having stored therein a program for causing a computer to execute a process. The process includes acquiring first information related to a linear circuit having a plurality of ports for receiving or outputting a high frequency signal, and second information related to a frequency of the high frequency signal, estimating, when the second information indicates that the frequency is 0 Hz, an S-parameter for two ports of the plurality of ports when the frequency is 0 Hz, from the first information based on a first learned model, and estimating, when the second information indicates that the frequency is other than 0 Hz, an S-parameter at the frequency from the first information and the second information, based on a second learned model. The first learned model is generated by performing machine learning on a plurality of pieces of first training data, the plurality of pieces of first training data defining a relationship between a plurality of pieces of first information of the linear circuit and a plurality of S-parameters. Each of the plurality of S-parameters is calculated for a corresponding one of the plurality of pieces of first information when the frequency is 0 Hz. The second learned model is generated by performing machine learning on a plurality of pieces of second training data, the plurality of pieces of second training data defining a relationship among the plurality of pieces of first information of the linear circuit, a plurality of frequencies, and a plurality of S-parameters. Each of the plurality of frequencies includes a frequency other than 0 Hz. Each of the plurality of S-parameters is calculated for a corresponding one of the plurality of pieces of first information and a corresponding one of the plurality of frequencies. This can improve the accuracy of the estimation of the S-parameter.

(2) In the above (1), each of the plurality of S-parameters in the plurality of pieces of first training data may be normalized by a first maximum value and a first minimum value. Each of the plurality of S-parameters in the plurality of pieces of second training data may be normalized by a second maximum value and a second minimum value. This can further improve the accuracy of the estimation of the S-parameter.

(3) In the above (2), a difference between the first maximum value and the first minimum value may be smaller than a difference between the second maximum value and the second minimum value. This can further improve the accuracy of the estimation of the S-parameter.

(4) In the above (3), the estimating the S-parameter based on the first learned model may estimate the S-parameter by decoding a value generated based on the first learned model, based on the first maximum value and the first minimum value. The estimating the S-parameter based on the second learned model may estimate the S-parameter by decoding a value generated based on the second learned model, based on the second maximum value and the second minimum value. This can further improve the accuracy of the estimation of the S-parameter.

(5) In any one of the above (1) to (4), the two ports may be opened or short-circuited when the frequency is 0 Hz. This can further improve the accuracy of the estimation of the S-parameter.

(6) In the above (5), when the two ports are port 1 and port 2, the S-parameter may include S21. This can further improve the accuracy of the estimation of the S-parameter.

(7) In any one of (1) to (6), the second learned model may be generated by performing machine learning on the plurality of pieces of second training data defining a relationship among the plurality of pieces of first information of the linear circuit, a plurality of frequencies including a frequency of 0 Hz and a frequency other than 0 Hz, and the plurality of S-parameters. Each of the plurality of S-parameters is calculated for a corresponding one of the plurality of pieces of first information and a corresponding one of the plurality of frequencies. This enables the estimation of the S-parameter with high accuracy.

(8) An embodiment according to the present disclosure is an estimation method that includes acquiring first information related to a linear circuit having a plurality of ports for receiving or outputting a high frequency signal, and second information related to a frequency of the high frequency signal; estimating, when the second information indicates that the frequency is 0 Hz, an S-parameter for two ports of the plurality of ports when the frequency is 0 Hz, from the first information based on a first learned model; and estimating, when the second information indicates that the frequency is other than 0 Hz, an S-parameter at the frequency from the first information and the second information, based on a second learned model. The first learned model is generated by performing machine learning on a plurality of pieces of first training data defining a relationship between a plurality of pieces of first information of the linear circuit and a plurality of S-parameters. Each of the plurality of S-parameters is calculated for a corresponding one of the plurality of pieces of first information when the frequency is 0 Hz. The second learned model is generated by performing machine learning on a plurality of pieces of second training data defining a relationship among the plurality of pieces of first information of the linear circuit, a plurality of frequencies, and a plurality of S-parameters. Each of the plurality of frequencies including a frequency other than 0 Hz. Each of the plurality of S-parameters is calculated for a corresponding one of the plurality of pieces of first information and a corresponding one of the plurality of frequencies. This can improve the accuracy of the estimation of the S-parameter.

(9) An embodiment according to the present disclosure is a learned model for estimating an S-parameter for two ports of a plurality of ports for receiving or outputting a high frequency signal, based on first information related to a linear circuit having the plurality of ports and second information related to a frequency of the high frequency signal. The learned model includes a first learned model and a second learned model. The first learned model is generated by performing machine learning on a plurality of pieces of first training data defining a relationship between a plurality of pieces of first information and a plurality of S-parameters. Each of the plurality of S-parameters is calculated for a corresponding one of the plurality of pieces of first information when the frequency is 0 Hz. The second learned model is generated by performing machine learning on a plurality of pieces of second training data defining a relationship among the plurality of pieces of first information, a plurality of frequencies, and a plurality of S-parameters, each of the plurality of frequencies including a frequency other than 0 Hz. Each of the plurality of S-parameters is calculated for a corresponding one of the plurality of pieces of first information and a corresponding one of the plurality of frequencies. This can improve the accuracy of the estimation of the S-parameter.

(10) An embodiment of the present disclosure is a method of generating a learned model for estimating an S-parameter for two ports of a plurality of ports for receiving or outputting a high frequency signal, based on first information related to a linear circuit having the plurality of ports and second information related to a frequency of the high frequency signal. The method includes generating a first learned model and generating a second learned model. The first learned model is generated by performing machine learning on a plurality of pieces of first training data defining a relationship between a plurality of pieces of first information and a plurality of S-parameters. Each of the plurality of S-parameters is calculated for a corresponding one of the plurality of pieces of first information when the frequency is 0 Hz. The second learned model is generated by machine learning on a plurality of pieces of second training data defining a relationship among the plurality of pieces of first information, a plurality of frequencies, and a plurality of S-parameters, each of the plurality of frequencies including a frequency other than 0 Hz. Each of the plurality of S-parameters is calculated for a corresponding one of the plurality of pieces of first information and a corresponding one of the plurality of frequencies. This can improve the accuracy of the estimation of the S-parameter.

(11) An embodiment of the present disclosure is an estimation device including an acquirer, a first estimator, and a second estimator. The acquirer acquires first information related to a linear circuit having a plurality of ports for receiving or outputting a high frequency signal, and second information related to a frequency of the high frequency signal. The first estimator estimates, when the second information indicates that the frequency is 0 Hz, an S-parameter for two ports of the plurality of ports when the frequency is 0 Hz, from the first information based on a first learned model. The second estimator estimates, when the second information indicates that the frequency is other than 0 Hz, an S-parameter at the frequency, from the first information and the second information based on a second learned model. The first learned model is generated by performing machine learning on a plurality of pieces of first training data defining a relationship between a plurality of pieces of first information of the linear circuit and a plurality of S-parameters. Each of the plurality of S-parameters is calculated for a corresponding one of the plurality of pieces of first information when the frequency is 0 Hz. The second learned model is generated by performing machine learning on a plurality of pieces of second training data defining a relationship among the plurality of pieces of first information of the linear circuit, a plurality of frequencies, and a plurality of S-parameters. Each of the plurality of frequencies including a frequency other than 0 Hz. Each of the plurality of S-parameters is calculated for a corresponding one of the plurality of pieces of first information and a corresponding one of the plurality of frequencies. This can improve the accuracy of the estimation of the S-parameter.

(12) An embodiment of the present disclosure is an estimation device including a memory and a processor. The processor is configured to acquire first information related to a linear circuit having a plurality of ports configured to receive or output a high frequency signal, and second information related to a frequency of the high frequency signal, configured to estimate, when the second information indicates that the frequency is 0 Hz, an S-parameter for two ports of the plurality of ports when the frequency is 0 Hz, based on a first learned model from the first information, and configured to estimate, when the second information indicates that the frequency is other than 0 Hz, an S-parameter at the frequency, based on a second learned model from the first information and the second information. The first learned model is generated by performing machine learning on a plurality of pieces of first training data, the plurality of pieces of first training data defining a relationship between a plurality of pieces of first information of the linear circuit and a plurality of S-parameters. Each of the plurality of S-parameters is calculated for a corresponding one of the plurality of pieces of first information when the frequency is 0 Hz. The second learned model is generated by performing machine learning on a plurality of pieces of second training data defining a relationship among the plurality of pieces of first information of the linear circuit, a plurality of frequencies and a plurality of S-parameters. Each of the plurality of frequencies includes a frequency other than 0 Hz. Each of the plurality of S-parameters is calculated for a corresponding one of the plurality of pieces of first information and a corresponding one of the plurality of frequencies. This can improve the accuracy of the estimation of the S-parameter.

### Details of Embodiments of Present Disclosure

Specific examples of a non-transitory computer-readable recording medium, a method, a learned model, and a method of generating a learned model according to the embodiments of the present disclosure will be described below with reference to the drawings. The present disclosure is not limited to these examples, but is defined by the scope of the claims, and is intended to include all modifications within the scope and meaning equivalent to the scope of the claims.

At least some of the embodiments described below may be combined as desired. The estimation device is configured to include a computer, and each function of the estimation device is achieved by a computer program stored in a storage device of the computer being executed by a central processing unit (CPU) of the computer. The computer program may be stored in a storage medium such as a compact disc read only memory (CD-ROM) or a digital versatile disc (DVD).

### First Embodiment

### [Linear Circuit]

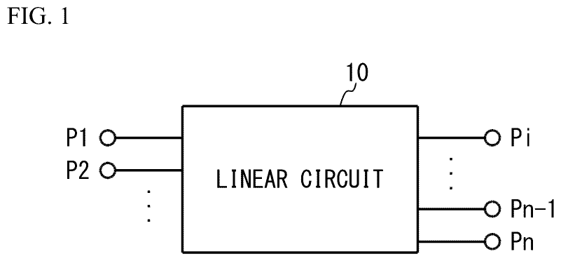

FIG. 1 is a block diagram of a linear circuit for estimating an S-parameter in a first embodiment. As illustrated in FIG. 1, a linear circuit 10 includes a plurality of ports P1, P2, . . . , Pi, . . . , Pn-1, and Pn to which a high frequency signal is received or output. Here, n is an integer corresponding to the number of ports P1 to Pn of linear circuit 10, and is 2 or more.

### Example 1 of Linear Circuit

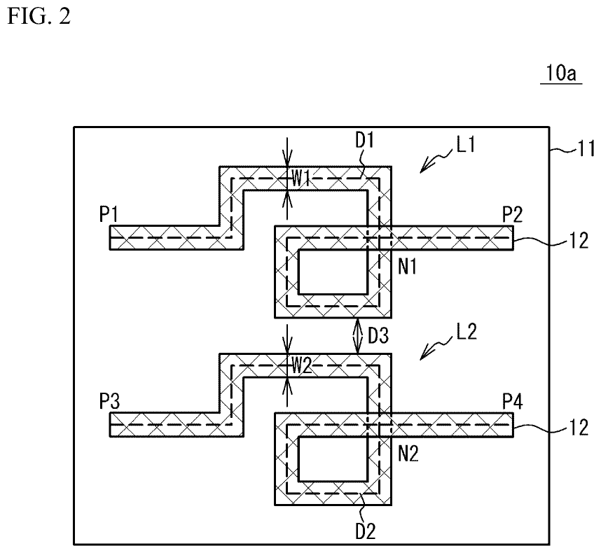

FIG. 2 is a plan view of an Example 1 of the linear circuit in the first embodiment. As illustrated in FIG. 2, in a linear circuit 10a of Example 1, a metal pattern 12 is provided on a dielectric substrate 11. Metal pattern 12 forms spiral-shaped inductors L1 and L2. Both ends of inductor L1 are denoted as ports P1 and P2, and both ends of inductor L2 are denoted as ports P3 and P4. For inductor L1, the line width is denoted as W1, the line length is denoted as D1, and the number of turns is denoted as N1. For inductor L2, the line width is denoted as W2, the line length is denoted as D2, and the number of turns is denoted as N2. The distance between inductor L1 and inductor L2 is denoted as D3.

### Example 2 of Linear Circuit

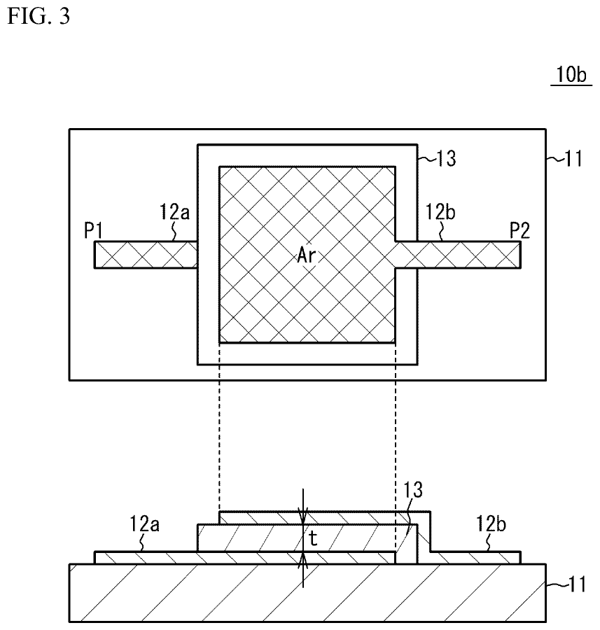

FIG. 3 is a plan view and a cross-sectional view of an Example 2 of the linear circuit in the first embodiment. As illustrated in FIG. 3, in a linear circuit 10b of Example 2, metal patterns 12a and 12b are provided on or above dielectric substrate 11. A dielectric layer 13 is provided between metal patterns 12a and 12b. Dielectric layer 13, and metal patterns 12a and 12b sandwiching dielectric layer 13 form a capacitor C. The thickness of dielectric layer 13 is denoted as t, and the area of the region where metal patterns 12a and 12b overlap with each other with dielectric layer 13 interposed therebetween is denoted as Ar. The end of metal pattern 12a and the end of metal pattern 12b are port P1 and port P2, respectively.

The information for estimating the S-parameter of linear circuit 10 is, for example, at least one of dimension information related to dimensions or physical property information related to physical properties of a material. In Example 1, the dimension information includes line widths W1 and W2, line lengths D1 and D2, numbers of turns N1 and N2, and distance D3. The physical property information includes the dielectric constant and loss tangent of dielectric substrate 11, the conductivity of metal pattern 12, and the like. In Example 2, the dimension information includes thickness t and area Ar. The physical property information includes the dielectric constant and loss tangent of dielectric layer 13, the conductivity of metal patterns 12a and 12b, and the like.

Linear circuit 10 is designed using an equivalent circuit represented by a lumped constant circuit using linear elements such as a resistor, an inductor, a capacitor, and a transmission line. Alternatively, a scattering matrix (S-parameter) for each frequency of a high frequency signal is used. In particular, the S-parameter is often used for circuit design for microwave (from 300 MHz to 30 GHz) or millimeter wave (from 30 GHz to 300 GHz) applications, for example.

### [S-Parameter]

The S-parameter (scattering matrix) of linear circuit 10 will be described. Equation 1 is a matrix of S-parameter of linear circuit 10.

$$S = [ \begin{matrix}S 11 & S 12 & … & S 1 n \\ S 21 & S 22 & … & S 2 n \\ ⋮ & ⋮ & Skl & ⋮ \\ Sn 1 & Sn 2 & … & Snn\end{matrix} ] \qquad [ Equation 1 ]$$

The S-parameter from a port Pk to a port P1 is denoted as an element Skl. Element Skl of the S-parameter is a complex number. In a linear circuit, Skl is equal to Slk. In Example 1 in FIG. 2, n is four (n=4), and in Example 2 in FIG. 3, n is two (n=2).

### [Linear Circuit Model Using Learned Model]

It is difficult for an equivalent circuit represented by lumped constants to express high-frequency characteristics with high accuracy in a wide band. Since the S-parameter represents the high-frequency characteristics for each frequency, it is possible to express the high-frequency characteristics with high accuracy in a wide band. However, the S-parameter needs to be calculated by performing the electromagnetic field analysis for each different parameter of the linear circuit. The electromagnetic field analysis requires time and man-hours. Thus, it is difficult to design a circuit by changing the dimension information of the linear circuit.

Thus, a circuit model by a neural network is proposed in which dimension information and physical property information of the linear circuit are set as explanatory variables and the S-parameter is set as an objective variable.

The estimation method of the S-parameter of the linear circuit according to the first embodiment will be described below.

### [Block Diagram of Computer]

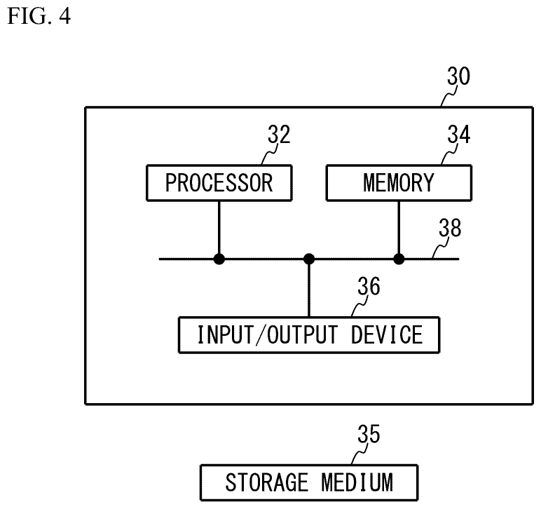

FIG. 4 is a block diagram of a computer in the first embodiment. A computer 30 functions as an estimation device that estimates the S-parameter of linear circuit 10 in cooperation with software. Computer 30 executes the estimation program to perform the estimation method.

Computer 30 includes a processor 32, a memory 34, an input/output device 36, and an internal bus 38. Processor 32 is, for example, a central processing unit (CPU), and executes a program and a method. Memory 34 is, for example, a volatile memory or a non-volatile memory, and stores data and the like used when processor 32 executes the program and the method. Memory 34 may store a program executed by processor 32. Input/output device 36 receives data to be acquired by processor 32 from an external apparatus, and outputs data output by processor 32 to the external apparatus. The external apparatus may be another computer or another program in the same computer. Internal bus 38 connects processor 32, memory 34, and input/output device 36 to each other, and transmits data and the like. The program is stored in a storage medium 35. Storage medium 35 is, for example, a non-transitory tangible medium, such as a CD-ROM or a DVD.

### [Method of Generating Training Data]

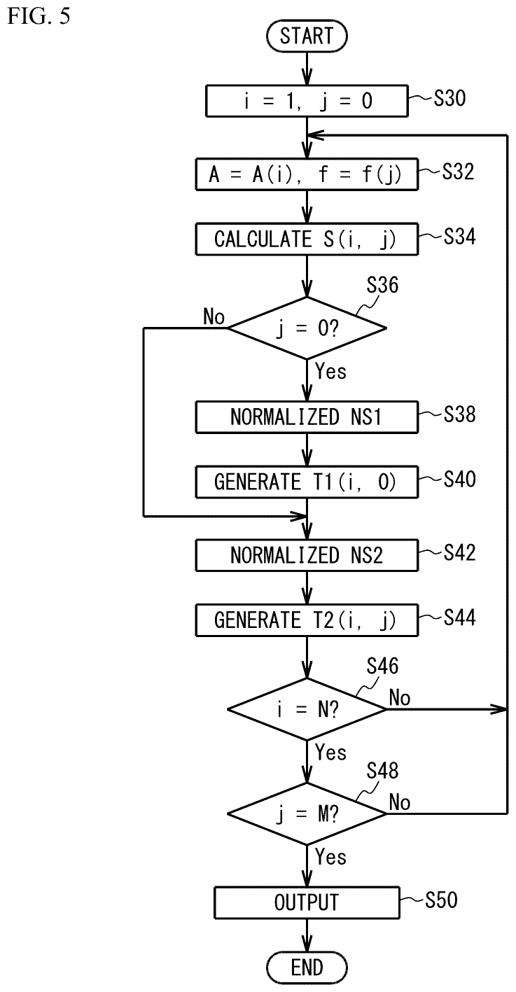

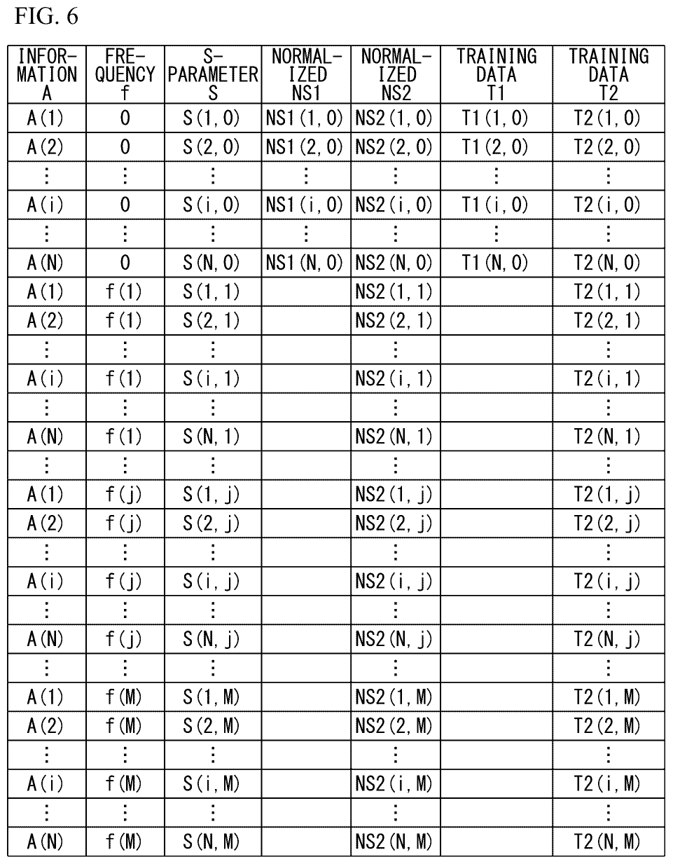

FIG. 5 is a flowchart illustrating a method of generating training data in the first embodiment. Each step in FIG. 5 may be performed by the computer illustrated in FIG. 4 or by a human. FIG. 6 is a diagram illustrating an example of the training data in the first embodiment.

As illustrated in FIG. 5, i and j are set to one and zero, respectively (step S30). Here, i is an integer from 1 to N, and j is an integer from 0 to M.

Next, information A is set to A (i), and a frequency f is set to f(j) (step S32). A (i) is, for example, dimension information and physical property information. When the material used for linear circuit 10 is fixed, the physical property information does not have to be used. In Example 1, dimension information includes D1 (i), D2 (i), W1 (i), W2 (i), N1 (i), N2 (i), and D3 (i). Here, i corresponds to 1 to N, and thus the value of the dimension information is varied with i. Frequency f(j) includes a frequency of 0 Hz and a frequency of other than 0 Hz. For j=0, f (0) is 0 Hz, for example.

Electromagnetic field analysis is performed based on information A (i) and frequency f (j) to calculate an S-parameter S (i, j) (step S34). Here, the matrix of the S-parameter is an n-by-n matrix as in Equation 1, and is a four-by-four matrix in Example 1 and a two-by-two matrix in Example 2. S-parameter S (i, j) is at least one element to be estimated among the elements of the matrix of Equation 1.

It is determined whether j is equal to zero or not (step S36). When the result is No, the process proceeds to step S42. When the result is Yes, calculated S-parameter S (i, j) is normalized (step S38). When S (i, j) includes a plurality of elements in the matrix of Equation 1, normalization is performed for each element. The maximum value for normalization is denoted as MAX1, and the minimum value is denoted as MIN1. When S (i, j) includes a plurality of elements, maximum value MAX1 and minimum value MIN1 may be set for each element. A normalized S-parameter NS1 (i, j) is equal to (S (i, j)−MIN1)/(MAX1+MIN1).

Training data T1 (i, 0) is generated (step S40). For example, for i=1 and j=0, training data T1 (1, 0) defining the relationship among information A (1), frequency f (0) of 0 Hz, and normalized S-parameter NS1 (1, 0) is generated as illustrated in FIG. 6.

Next, the calculated S (i, j) is normalized (step S42). The maximum value for normalization is denoted as MAX2, and the minimum value is denoted as MIN2. MAX2 is different from MAX1, and MIN2 is different from MIN1. MAX2 minus MIN2 is greater than MAX1 minus MIN1. When S (i, j) includes a plurality of elements, maximum value MAX2 and minimum value MIN2 may be set for each element. A normalized S-parameter NS2 (i, j) is equal to (S (i, j)−MIN2)/(MAX2+MIN2).

Training data T2 (i, j) is generated (step S44). For example, for i=1 and j=0, training data T2 (1, 0) defining the relationship between information A (1), frequency f (0) being equal to 0 Hz, and normalized S-parameter NS2 (1, 0) is generated as illustrated in FIG. 6.

Next, it is determined whether i is equal to N or not (step S46). When the result is No, the process returns to step S32. When the result is Yes, it is determined whether j is equal to M (step S48). When the result is No, the process returns to step S32.

As described above, when frequency f (0) is 0 Hz, N pieces of training data T1 (i, 0) defining the relationship between information A (i) and S-parameter S (i, 0) are generated.

In addition, N×(M+1) pieces of training data T2 (i, j) defining the relationship among information A (i), frequency f (j), and S-parameter S (i, 0) are generated.

In step S48, when the result is Yes, training data T1 and training data T2 are output to memory 34 or the external apparatus (step S50). Thereafter, the process is completed.

### [Method of Generating Learned Model]

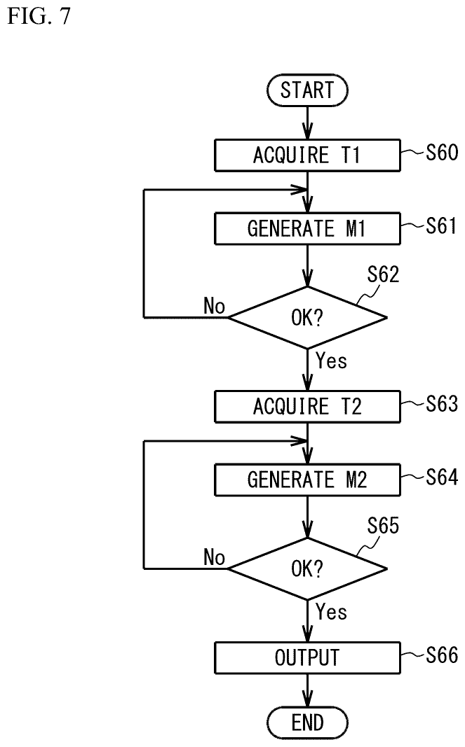

FIG. 7 is a flowchart illustrating a method of generating a learned model in the first embodiment. As illustrated in FIG. 7, processor 32 acquires N pieces of training data T1 from memory 34 or the external apparatus (step S60). Processor 32 performs machine learning based on the N pieces of acquired training data T1, and generates a first learned model M1 (step S61). Processor 32 or a human verifies first learned model M1 (step S62). For example, S-parameter S is estimated from information A whose relationship with S-parameter is known, using first learned model M1. When the estimated S-parameter substantially matches the known S-parameter, the result is determined as YES in step S62, and when the estimated S-parameter does not match the known S-parameter, the result is determined as NO. When the result is NO, the process returns to step S61.

When the result is YES in step S62, processor 32 acquires N×(M+1) pieces of training data T2 from memory 34 or the external apparatus (step S63). Processor 32 performs machine learning based on the acquired N×(M+1) pieces of training data T2, and generates a second learned model M2 (step S64). Processor 32 or a human verifies second learned model M2 (step S65). The verification method is the same as that in step S62. When the result is NO, the process returns to step S64. When the result is YES, first learned model M1 and second learned model M2 are output to memory 34 or the external apparatus (step S66). Thereafter, the process is completed. In FIG. 7, steps S60 to S62 are performed before steps S63 to S65. However, steps S63 to S65 may be performed first, and then steps S60 to S62 may be performed. As described above, first learned model M1 and second learned model M2 are generated.

### [Estimation Method of S-Parameter]

### [Functional Block Diagram]

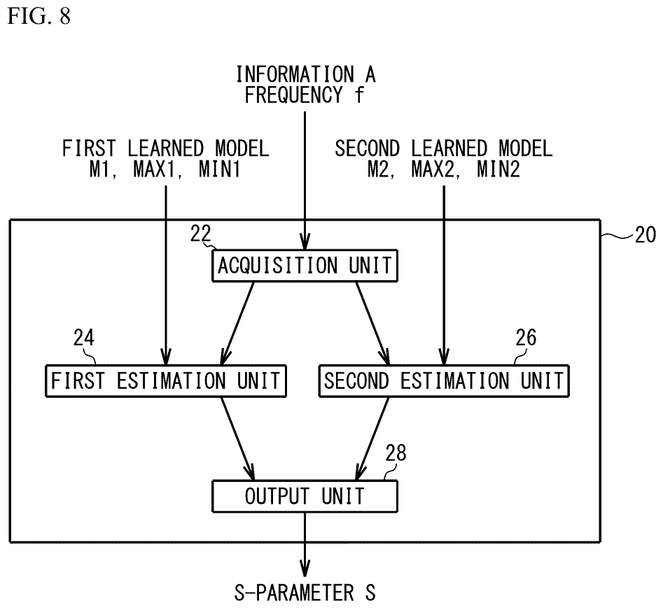

FIG. 8 is a functional block diagram of an estimation device in the first embodiment. As illustrated in FIG. 8, an estimation device 20 includes an acquisition unit 22, a first estimation unit 24, a second estimation unit 26, and an output unit 28. Processor 32 cooperates with software to function as acquisition unit 22, first estimation unit 24, second estimation unit 26, and output unit 28. Acquisition unit 22 acquires information A, frequency f, and the like of linear circuit 10 from the external apparatus via input/output device 36. When frequency f is 0 Hz, first estimation unit 24 estimates S-parameter S from information A and frequency f based on first learned model M1. When frequency f is other than 0 Hz, second estimation unit 26 estimates S-parameter S from information A and frequency f based on second learned model M2. Output unit 28 outputs S-parameter S estimated by first estimation unit 24 or second estimation unit 26 to the external apparatus via input/output device 36.

### [Flowchart]

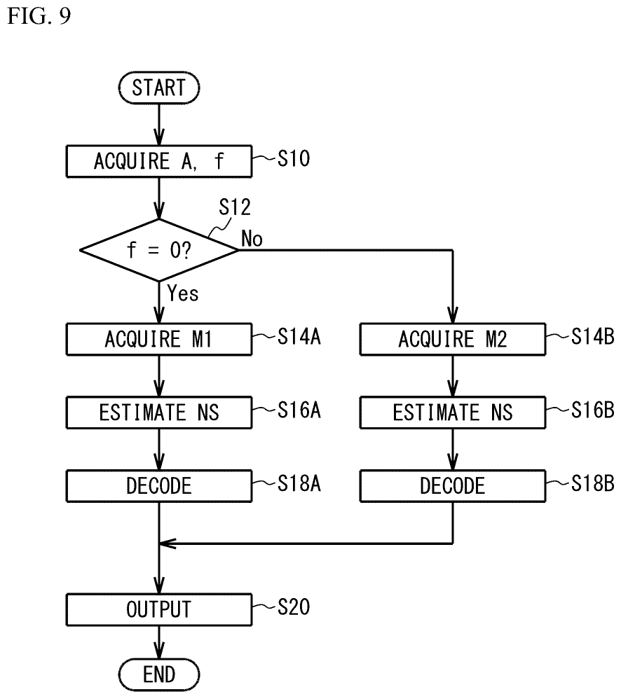

FIG. 9 is a flowchart illustrating a method of estimating the S-parameter in the first embodiment. As illustrated in FIG. 9, acquisition unit 22 acquires information A (first information) related to linear circuit 10 and information (second information) related to frequency f of the high frequency signal (step S10).

Processor 32 determines whether frequency f is 0 Hz or not (step S12). When the result is Yes, first estimation unit 24 acquires first learned model M1 (step S14A). First estimation unit 24 may acquire maximum value MAX1 and minimum value MIN1 for normalization in addition to first learned model M1. First estimation unit 24 applies first learned model M1 to information A, and estimates a normalized S-parameter NS (step S16A).

First estimation unit 24 decodes normalized S-parameter NS (step S18A). Decoded S-parameter S can be calculated by the equation of S=NS×(MAX1+MIN1)+MIN1 using normalized S-parameter NS. When normalized S-parameter NS includes a plurality of elements of the matrix, the S-parameter may be calculated for each element. Thereafter, output unit 28 outputs S-parameter S to memory 34 or the external apparatus (step S20). Thereafter, the process is completed.

When the result is No in step S12, second estimation unit 26 acquires second learned model M2 (step S14B). Second estimation unit 26 may acquire maximum value MAX2 and minimum value MIN2 for normalization, in addition to second learned model M2. Second estimation unit 26 applies second learned model M2 to information A and frequency f, and estimates normalized S-parameter NS (step S16B).

Second estimation unit 26 decodes normalized S-parameter NS (step S18B). Decoded S-parameter S can be calculated by the equation of S=NS×(MAX2+MIN2)+MIN2. When normalized S-parameter NS includes a plurality of elements of the matrix, the S-parameter may be calculated for each element. Thereafter, output unit 28 outputs S-parameter S to memory 34 or the external apparatus. Thereafter, the process is completed.

### First Comparative Example

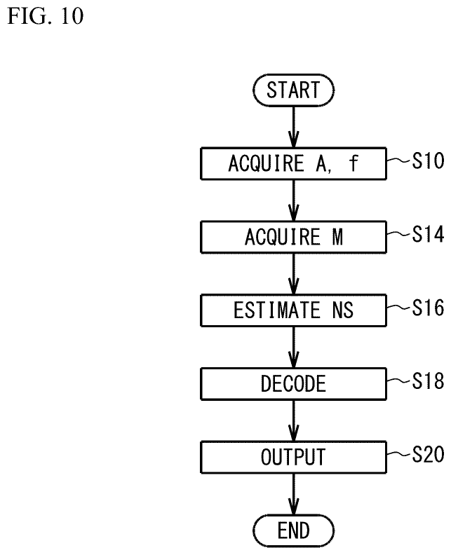

FIG. 10 is a flowchart illustrating a method of estimating an S-parameter in a first comparative example. As illustrated in FIG. 10, in the first comparative example, step S12 of FIG. 9 in the first embodiment is not provided. After step S10, processor 32 acquires a model M corresponding to second learned model M2 as a learned model regardless of frequency f (step S14). The acquired learned model M is applied to information A and frequency f, and estimates normalized S-parameter NS (step S16). Processor 32 decodes normalized S-parameter NS by using MAX2 and MIN2 (step S18). Thus, S-parameter S is generated. Thereafter, processor 32 outputs S-parameter S (step S20).

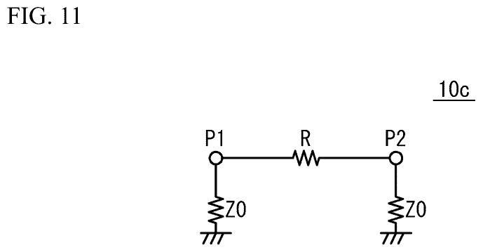

The problem of the first comparative example will be described for a linear circuit of a resistor R. FIG. 11 is an equivalent circuit of the linear circuit. As illustrated in FIG. 11, in a linear circuit 10c, resistor R is electrically connected between ports P1 and P2. Ports P1 and P2 are terminated with a reference impedance Z0 (e.g., 50Ω).

At direct current (that is, when the frequency is 0 Hz), S21 in the matrix of the S-parameter of linear circuit 10c is considered. Since resistor R has almost no reactance components, S21 is almost a real number. Thus, the description will be provided considering S21 as the real number part of S21. When the resistance value of resistor R is denoted as R and the impedance (resistance value because of a real number) of the reference impedance is denoted as Z0, S21 is equal to 2×Z0/(R+2×Z0).

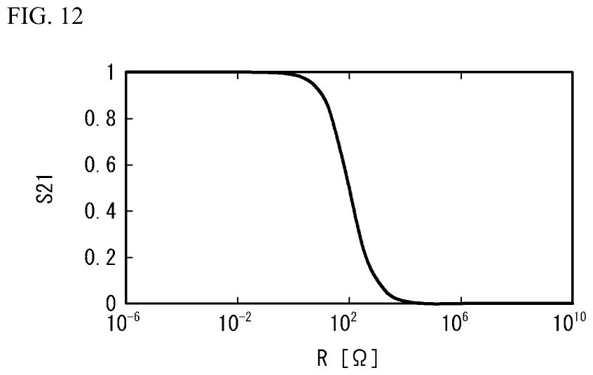

Here, Z0 is set to 50Ω. FIG. 12 is a diagram illustrating S21 versus a resistance value R of resistor R. As illustrated in FIG. 12, at a resistance value R of 100Ω, S21 is 0.5. At a resistance value R of 1Ω or less, S21 is approximately one. At a resistance value R of 10000Ω or more, S21 is approximately zero. For a small resistance value R, ports P1 and P2 are short-circuited, and for a large resistance value R, ports P1 and P2 are opened.

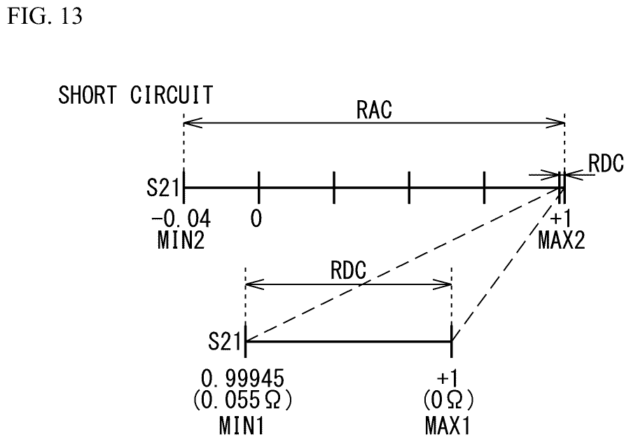

FIG. 13 is a diagram illustrating S21 when ports P1 and P2 are short-circuited at direct current. In FIG. 13, the horizontal direction represents S21. The lower part is an enlarged view of the range of S21 near +1 in the upper part. When the ports are short-circuited at direct current, a range RDC that S21 can take is close to +1, for example, from +0.99945 to +1. This corresponds to a resistance value R of 0.055Ω to 0Ω. On the other hand, at alternating current, S21 can take a range RAC from −0.04 to +1. For example, ports P1 and P2 of Example 1 are short-circuited at direct current. However, this is because the impedance of inductor L1 is j (2πf) L1 (j is an imaginary unit) at an alternating current of frequency f.

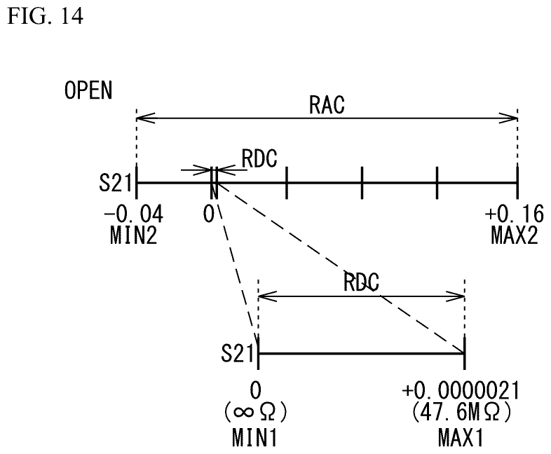

FIG. 14 is a diagram illustrating S21 when ports P1 and P2 are opened at direct current. In FIG. 14, the horizontal direction represents S21. The lower part is an enlarged view of the range of S21 near zero in the upper part. When the ports are opened at direct current, range RDC that S21 can take is close to zero, for example, from 0 to +0.0000021. This corresponds to a resistance value from infinitely large Ω to 47.6 MΩ. On the other hand, at alternating current, S21 can take range RAC from −0.04 to +0.16. For example, ports P1 and P2 in Example 2 are opened at direct current. However, this is because the impedance of capacitor C is −1/j (2πf) C (j is an imaginary unit) at an alternating current with frequency f.

In the first comparative example, the same learned model is used regardless of direct current and alternating current. For example, for opened circuit at direct current, range RAC is used for normalization. In this case, maximum value MAX2 and minimum value MIN2 are used.

When the resistance value R between ports P1 and P2 at direct current is 100 MΩ, the real number part of S21 is 1×10⁻⁶. Normalizing S21 under the condition of MAX2=0.16 and MIN2=−0.04, NS21 is determined to be (1×10⁻⁶−(−0.04))/(0.16+(−0.04))=0.200005. The learned model is generated based on NS21 described above.

If NS21 has an error of 0.001 relative to 0.200005 when NS21 is estimated using the learned model at step S16 in FIG. 10, S21 is determined to be 0.201005×(0.16−(−0.04))+(−0.04)=0.000201 in the decoding step of step S18. This value of S21 corresponds to 500 kΩ, and resistance value R becomes 1/200 of 100 MΩ due to an error of 0.0001.

As illustrated in FIG. 12, for short or opened circuit at direct current, S21 hardly changes even when resistance value R changes. Thus, when S21 is estimated by normalizing and decoding at alternating current and direct current, the error of resistance value R becomes large for direct current.

### First Embodiment

Thus, in the first embodiment, range RDC is used for normalizing and decoding data for a frequency of 0 Hz when the ports are opened at direct current. In this case, maximum value MAX1 and minimum value MIN1 are used.

The resistance value between ports P1 and P2 is 100 MΩ at direct current, and the real number part of S21 is 1×10⁻⁶. Normalizing S21 under the condition of MAX1=+0.0000021 and MIN2=0, NS21 is determined to be (1×10⁻⁶−0)/(0.0000021+0)=0.47619.

If NS21 has an error of 0.001 relative to 0.47619, S21 is determined to be 0.47719×(0.0000021+0)−0=1.0021×10⁻⁶ in the decoding step of step S18, and this value of S21 corresponds to a resistance value R of approximately 100 MΩ. Thus, even when there is an error, resistance value R does not change significantly.

According to the first embodiment, as illustrated in FIG. 8 and FIG. 9, when frequency f is 0 Hz, first estimation unit 24 estimates S-parameter S from information A based on first learned model M1. When frequency f is other than 0 Hz, second estimation unit 26 estimates S-parameter S at frequency f from information A and frequency f based on second learned model M2. As illustrated in FIG. 5 and FIG. 6, first learned model M1 is generated by machine learning on a plurality of pieces of training data T1 (i, 0) (first training data) defining the relationship between a plurality of pieces of information A (i) of linear circuit 10, and a plurality of S-parameters S (i, 0) calculated for a corresponding one of the plurality pieces of information A (i) when frequency fis 0 Hz. Second learned model M2 is generated by machine learning on a plurality of pieces of training data T2 (i, j) (second training data) defining a relationship among the plurality of pieces of information A (i), a plurality of frequencies f(j) including a frequency other than 0 Hz, and a plurality of S-parameters S (i, j) calculated for a corresponding one of the plurality of pieces of information A (i) and a corresponding one of the plurality of frequencies f(j).

As described above, S-parameter S for direct current whose frequency f is 0 Hz is estimated using first learned model M1 generated using training data T1 (i, 0) when frequency f is 0 Hz. S-parameter S for alternating current whose frequency f is other than 0 Hz is estimated using second learned model M2 generated using training data T2 (i, 0) including the case in which frequency f is other than 0 Hz. This can improve the accuracy of estimation of S-parameter S for direct current and estimation of the S-parameter for alternating current. In this manner, the accuracy of the model can be improved. The S-parameters to be estimated are S-parameters for two ports among the plurality of ports P1 to Pn in FIG. 1.

For all elements in the matrix of the S-parameter, the S-parameter may be estimated. For some elements in the matrix of the S-parameter, the S-parameter does not have to be estimated. For some elements of the S-parameter, the S-parameter may be estimated using first learned model M1 and second learned model M2. For other elements, the S-parameter may be estimated using second learned model M2 for both of a frequency f of 0 Hz and a frequency f other than 0 Hz.

The S-parameter in training data T1 (i, 0) is normalized by maximum value MAX1 (first maximum value) and minimum value MIN1 (first minimum value). The S-parameter in training data T2 (i, j) is normalized by maximum value MAX2 (second maximum value) and minimum value MIN2 (second minimum value). In this manner, training data T1 (i, 0) and T2 (i, j) are normalized using different maximum values and minimum values from each other. Thus, even when the maximum value and the minimum value of the S-parameter for direct current are significantly different from the maximum value and the minimum value of the S-parameter for alternating current, the S-parameter can be estimated with high accuracy.

The difference between maximum value MAX1 and minimum value MIN1 is smaller than the difference between maximum value MAX2 and minimum value MIN2. Thus, even when range RDC of the S-parameter for direct current is smaller than range RAC of the S-parameter for alternating current, the S-parameter can be estimated with high accuracy. Range RDC is, for example, 1/10 or less of range RAC, and is 1/100 or less of range RAC.

First estimation unit 24 estimates the S-parameter by decoding the value generated based on first learned model M1 based on maximum value MAX1 and minimum value MIN1. Second estimation unit 26 estimates the S-parameter by decoding the value generated based on second learned model M2 based on maximum value MAX2 and minimum value MIN2. Thus, even when the maximum value and the minimum value of the S-parameter for direct current are significantly different from the maximum value and the minimum value of the S-parameter for alternating current, the S-parameter can be estimated with high accuracy.

The S-parameter to be estimated is for open or short circuit between the ports at a frequency f of 0 Hz. In this case, when the method in the first comparative example is used, the accuracy of the estimation of the S-parameter is reduced. Thus, by estimating the S-parameter using the method in the first embodiment, the accuracy of the estimation of the S-parameter can be improved.

When the S-parameter is S21, the accuracy of the estimation of the S-parameter is lowered by using the method in the first comparative example as described with reference to FIGS. 13 and 14. Thus, by estimating the S-parameter using the method in the first embodiment, the accuracy of the estimation of the S-parameter can be improved. In linear circuit 10, S21 and S12 are equivalent to each other.

When training data T2 (i, j) does not include the data for a frequency f of 0 Hz, the case where the S-parameter at frequency f between frequency f (0) of 0 Hz and frequency f (1), which is the lowest and other than 0 Hz in the training data, is estimated will be considered. In this case, the S-parameter at frequency f outside the frequency range of training data T2 is estimated, and the S-parameter cannot be estimated with high accuracy. Thus, second learned model M2 is generated by performing machine learning on training data T2 (i, j) in which frequency f includes both a frequency of 0 Hz and a frequency other than 0 Hz. Thus, even when the S-parameter at frequency f between frequency f (0) and frequency f (1) is estimated, the S-parameter can be estimated with high accuracy.

Each process (each function) of the above-described embodiments is implemented by a circuitry including one or more processors. The circuitry may be configured by an integrated circuit or the like in which one or more memories, various analog circuits, and various digital circuits are combined in addition to the one or more processors. The one or more memories store a program (command) for causing the one or more processors to execute the processes. The one or more processors may execute the processes in accordance with the program read from the one or more memories, or may execute the processes in accordance with a logic circuit designed in advance to execute the processes.

The processor may be any of various processors suitable for control of a computer, such as a CPU, a graphics processing unit (GPU), a digital signal processor (DSP), a field programmable gate array (FPGA), and an application specification integrated circuit (ASIC). The plurality of processors physically separated from each other may execute the processes in cooperation with each other. For example, the processors mounted on a plurality of physically separated computers may execute the processes in cooperation with each other via a network such as a local area network (LAN), a wide area network (WAN), or the Internet.

The program may be installed in the memory from an external server device or the like via the network, or may be distributed in a state of being stored in a recording medium such as a CD-ROM, a DVD-ROM, or a semiconductor memory and installed in the memory from the recording medium.

The embodiments disclosed herein are to be considered as illustrative and non-restrictive in all respects. The scope of the present disclosure is defined by the claims, not in the sense described above, and is intended to include all modifications within the scope and meaning equivalent to the scope of the claims.

The invention claimed is:

1. A non-transitory computer-readable recording medium having stored therein a program for causing a computer to execute a process, the process comprising:
acquiring first information related to a linear circuit having a plurality of ports for receiving or outputting a high frequency signal, and second information related to a frequency of the high frequency signal;
estimating, when the second information indicates that the frequency is 0 Hz, an S-parameter for two ports of the plurality of ports when the frequency is 0 Hz, from the first information based on a first learned model; and
estimating, when the second information indicates that the frequency is other than 0 Hz, an S-parameter at the frequency from the first information and the second information, based on a second learned model, wherein
the first learned model is generated by performing machine learning on a plurality of pieces of first training data, the plurality of pieces of first training data defining a relationship between a plurality of pieces of first information of the linear circuit and a plurality of S-parameters, each of the plurality of S-parameters being calculated for a corresponding one of the plurality of pieces of first information when the frequency is 0 Hz, and
the second learned model is generated by performing machine learning on a plurality of pieces of second training data, the plurality of pieces of second training data defining a relationship among the plurality of pieces of first information of the linear circuit, a plurality of frequencies, and a plurality of S-parameters, each of the plurality of frequencies including a frequency other than 0 Hz, each of the plurality of S-parameters being calculated for a corresponding one of the plurality of pieces of first information and a corresponding one of the plurality of frequencies.

2. The non-transitory computer-readable recording medium according to claim 1, wherein
each of the plurality of S-parameters in the plurality of pieces of first training data is normalized by a first maximum value and a first minimum value, and
each of the plurality of S-parameters in the plurality of pieces of second training data is normalized by a second maximum value and a second minimum value.

3. The non-transitory computer-readable recording medium according to claim 2, wherein a difference between the first maximum value and the first minimum value is smaller than a difference between the second maximum value and the second minimum value.

4. The non-transitory computer-readable recording medium according to claim 3, wherein
the estimating the S-parameter based on the first learned model estimates the S-parameter by decoding a value generated based on the first learned model, based on the first maximum value and the first minimum value, and
the estimating the S-parameter based on the second learned model estimates the S-parameter by decoding a value generated based on the second learned model, based on the second maximum value and the second minimum value.

5. The non-transitory computer-readable recording medium according to claim 1, wherein the two ports are opened or short-circuited when the frequency is 0 Hz.

6. The non-transitory computer-readable recording medium according to claim 5, wherein when the two ports are port 1 and port 2, the S-parameter includes S21.

7. The non-transitory computer-readable recording medium according to claim 1, wherein
the second learned model is generated by performing machine learning on the plurality of pieces of second training data, the plurality of pieces of second training data defining a relationship among the plurality of pieces of first information of the linear circuit, a plurality of frequencies including a frequency of 0 Hz and a frequency other than 0 Hz, and the plurality of S-parameters, each of the plurality of S-parameters being calculated for a corresponding one of the plurality of pieces of first information and a corresponding one of the plurality of frequencies.

8. An estimation method comprising:
acquiring first information related to a linear circuit having a plurality of ports for receiving or outputting a high frequency signal, and second information related to a frequency of the high frequency signal;
estimating, when the second information indicates that the frequency is 0 Hz, an S-parameter for two ports of the plurality of ports when the frequency is 0 Hz, from the first information based on a first learned model; and
estimating, when the second information indicates that the frequency is other than 0 Hz, an S-parameter at the frequency from the first information and the second information, based on a second learned model, wherein
the first learned model is generated by performing machine learning on a plurality of pieces of first training data, the plurality of pieces of first training data defining a relationship between a plurality of pieces of first information of the linear circuit and a plurality of S-parameters, each of the plurality of S-parameters being calculated for a corresponding one of the plurality of pieces of first information when the frequency is 0 Hz, and
the second learned model is generated by performing machine learning on a plurality of pieces of second training data, the plurality of pieces of second training data defining a relationship among the plurality of pieces of first information of the linear circuit, a plurality of frequencies, and a plurality of S-parameters, each of the plurality of frequencies including a frequency other than 0 Hz, each of the plurality of S-parameters being calculated for a corresponding one of the plurality of pieces of first information and a corresponding one of the plurality of frequencies.

9. A learned model for estimating an S-parameter for two ports of a plurality of ports for receiving or outputting a high frequency signal, based on first information related to a linear circuit having the plurality of ports and second information related to a frequency of the high frequency signal, the learned model comprising:
a first learned model generated by performing machine learning on a plurality of pieces of first training data, the plurality of pieces of first training data defining a relationship between a plurality of pieces of first information and a plurality of S-parameters, each of the plurality of S-parameters being calculated for a corresponding one of the plurality of pieces of first information when the frequency is 0 Hz; and
a second learned model generated by performing machine learning on a plurality of pieces of second training data, the plurality of pieces of second training data defining a relationship among the plurality of pieces of first information, a plurality of frequencies, and a plurality of S-parameters, each of the plurality of frequencies including a frequency other than 0 Hz, each of the plurality of S-parameters being calculated for a corresponding one of the plurality of pieces of first information and a corresponding one of the plurality of frequencies.

10. A method of generating a learned model for estimating an S-parameter for two ports of a plurality of ports for receiving or outputting a high frequency signal, based on first information related to a linear circuit having the plurality of ports and second information related to a frequency of the high frequency signal, the method comprising:
generating a first learned model by performing machine learning on a plurality of pieces of first training data, the plurality of pieces of first training data defining a relationship between a plurality of pieces of first information and a plurality of S-parameters, each of the plurality of S-parameters being calculated for a corresponding one of the plurality of pieces of first information when the frequency is 0 Hz; and
generating a second learned model by performing machine learning on a plurality of pieces of second training data, the plurality of pieces of second training data defining a relationship among the plurality of pieces of first information, a plurality of frequencies, and a plurality of S-parameters, each of the plurality of frequencies including a frequency other than 0 Hz, each of the plurality of S-parameters being calculated for a corresponding one of the plurality of pieces of first information and a corresponding one of the plurality of frequencies.
